(19) United States
(12) Patent Application Publication
(10) Pub. No.: US 2026/0028965 A1
(43) Pub. Date: Jan. 29, 2026

(54) METHOD FOR MONITORING ONE OR MORE ELECTRIC DRIVES OF AN ELECTROMECHANICAL SYSTEM

(71) Applicant: PROKON Regenerative Energien eG, Itzehoe (DE)

(72) Inventor: Ivo BALZER, Siehdichum (DE)

(73) Assignee: PROKON Regenerative Energien eG, Itzehoe (DE)

(21) Appl. No.: 19/350,220

(22) Filed: Oct. 6, 2025

Related U.S. Application Data
(63) Continuation of application No. 18/023,428, now abandoned.

(30) Foreign Application Priority Data
Oct. 9, 2020 (DE) 10 2020 126 587.5

(51) Int. Cl. F03D 17/00; F03D 7/02; F03D 15/00; F03D 80/70; H02P 9/00; H02P 101/15

(52) U.S. Cl. CPC F03D 17/00; F03D 7/0204; F03D 15/00; F03D 80/70; H02P 9/006; H02P 2101/15

(57) ABSTRACT

A method monitors one or more electric drives of an electromechanical installation, particularly a wind orientation control of a wind turbine. The drive or drives work on a movable machine element of the installation, e.g., on a bearing ring of an azimuth bearing. A plurality of currents, e.g., phase currents of a plurality of phases, and/or a plurality of drives are measured during the operation of the drives at a predetermined sampling rate and are stored as series of measurement values with a predetermined quantity m of measurement values. Statistical characteristic values are calculated from one or more series of measurement values, and one or more pieces of state information and/or one or more state prognoses are/is generated for one or more drives through analysis of the time evolution of the characteristic values and/or through analysis of a relationship of the characteristic values of different motor currents.

### CROSS REFERENCE TO RELATED APPLICATIONS

This application is a continuation under 35 USC § 120 of U.S. patent application Ser. No. 18/023,428 filed on Feb. 27, 2023, which is the National Stage of PCT/EP2021/076254 filed on Sep. 23, 2021, which claims priority under 35 U.S.C. § 119 of German Application No. 10 2020 126 587.5 filed on Oct. 9, 2020, the disclosures of all of which are incorporated by reference herein. The international application under PCT article 21(2) was not published in English.

### BACKGROUND OF THE INVENTION

### 1. Field of the Invention

The invention is directed to a method and an installation for monitoring or analyzing one or more electric drives of an electromechanical installation, e.g., a wind orientation control of a wind turbine, in which the drive or drives operate, e.g., as servomotors, on a movable machine element of the installation, e.g., on a bearing ring of an azimuth bearing.

The electromechanical installation is, e.g., a wind orientation control of a wind turbine by which the nacelle of the wind turbine is held or adjusted in direction of the prevailing wind direction. For this purpose, the nacelle of the wind turbine is rotatably supported on a tower or tower head. In large installations, the wind direction tracking is carried out actively by means of one or more drives which are preferably formed as electric drives. These drives, also called azimuth drives, work as servomotors, e.g., on the bearing ring of the azimuth bearing or tower head bearing which can be, e.g., a large rolling element bearing with outer toothing or inner toothing. The drives can be formed, e.g., as gearbox motors with an output-side pinion, a plurality of coaxial planetary gear steps and a flanged AC motor. A standstill brake may possibly be integrated in the motor. Additionally, for example, one or more azimuth brakes are implemented. The latter are implemented in different variants, e.g., with internal toothing of the azimuth bearing with internal azimuth brake or with internal toothing of the azimuth bearing with external azimuth brake, and with external toothing of the azimuth bearing with internal azimuth brake or external toothing of the azimuth bearing with external azimuth brake. A plurality of electric motor drives, all of which work on a bearing ring of the azimuth bearing, are always provided.

The electric drives are formed, e.g., as single-phase or polyphase AC drives or three-phase drives, that is, they are operated with single-phase or polyphase alternating current (three-phase current). Alternatively, the invention also comprises installations with one or more DC drives.

### 2. The Prior Art

Wind turbines and particularly the wind orientation control thereof are exposed to high loads in practice and are thus subject to wear so that damage can occur. Reliable detection of damage to the wind orientation control and particularly to the drives of the wind orientation control is highly important in practice because outages lead to downtimes and, therefore, high costs or damages for the operator. In installations known in practice, damage to the drives of the wind orientation control have previously been detected only in an unreliable matter. As a result, if damage to one drive is not detected, further components, e.g., further gear units and electric motors or ring gears or bearings can be damaged or destroyed. Known passive protective measures are insufficient to stop a fault propagation of this kind. This has to do with the fact that the currents of the electric motors which can generally be utilized to monitor the drive are prone to be highly dynamic, and variations in current consumption occur constantly and can even be permanent. Such variations in current consumption result, e.g., from wind load on the nacelle, imbalance of the rotor blades, speed of the rotor, imbalance of the generator, temperature of the motor winding and cabling, slippage of the motor, inaccurate measurements, motor tolerances (current consumption), ring gear tolerances, motor gearbox tolerances, the state of the motor brake and/or state of the nacelle bearing. It is also owing to the highly dynamic current consumption of the electric motors that a gradual onset of defects in the drives cannot always be reliably detected with a conventional (manual) current measurement in a maintenance context or during a service call.

In addition, defective drives mostly put out normal values in current consumption so that the usual protections (motor circuit breaker or power circuit breaker) are not triggered. Apart from this, the nacelle also usually continues to be oriented toward the wind when one or more drives are defective because the remaining, properly functioning drives take over the operation. In so doing, these drives are excessively loaded. However, even such excessive loading of the rest of the drives does not lead to a triggering of the protective equipment because the wind orientation control system does not move permanently but only for a few seconds on the average, which cannot lead to a triggering of the thermal protection device during an average increased current. Further damage to the drive can result from the additional loading of the remaining drives. The conventional protective equipment often is not triggered until, e.g., three of four drives are defective and the last remaining drive is so highly loaded that thermal protection devices are triggered or the installation control is halted because of the absence of wind orientation control.

A condition monitoring system for a motor is known, e.g., from WO 2011/069545. The condition monitoring function of the motor is achieved by means of the motor end shield. For this purpose, the motor end shield comprises a sensor unit for detecting a measured quantity of the motor, communication means and a supply unit for supplying the sensor unit with power. The sensor unit can have, e.g., means for bearing current measurement or for measuring the temperature of the motor or the imbalance of the motor or also acoustic vibrations. The usual defects occurring in a wind orientation control cannot be reliably detected with a condition monitoring system of this kind because the measured quantities of the electric motors remain within the normal range until a properly functioning drive takes over the wind orientation control, as experience has shown. This is where the invention comes into play.

Further, US 2008/0183428 A1 describes a method for monitoring the operation of a tape drive used as storage medium. Motor currents of the drives of a tape drive of this kind are measured and compared with previously stored theoretical values. Statistical values can be determined both for the measured currents and for the theoretical currents and compared with one another. The analysis is always carried out based on current values calculated theoretically beforehand.

US 2016/0371958 A1 discloses a fitness device, namely, a treadmill, whose operation and wear are to be monitored. To this end, the motor current is recorded at different speeds of the treadmill so that measurement values are recorded at different speeds and these measurement values are weighted differently, namely, as a function of speed.

Lastly, US 2006/0250102 A1 is directed to a method for controlling or monitoring a motor in which, e.g., the current of a motor can be measured as operating parameter. The current is compared with threshold values and limiting values which can be determined from statistically acquired values.

### SUMMARY OF THE INVENTION

The invention has the object of providing a method by which one or more electric drives of an electromechanical installation can be analyzed and/or monitored in a simple and reliable manner, particularly in order to promptly and reliably detect damage and/or appearances of wear in individual drives or prevent the same before they occur.

In order to meet this object, the invention teaches in a generic method for monitoring one or more electric drives of an electromechanical installation that one or more motor currents of one or more drives are measured during the operation of the drive or drives at a predetermined sampling rate and are stored as series of measurement values associated with the respective current (or phase) of the respective drive and having a predetermined quantity of measurement values in each instance, in that statistical characteristic values are calculated from one or more series of measurement values in each instance (and possibly intermediately stored), and in that one or more pieces of state information and/or one or more state prognoses are/is generated for one or more drives through analysis of the time evolution of the characteristic values and/or through analysis of a relationship of the characteristic values of different motor currents.

According to the invention, the current or currents, e.g., the individual phase currents of one or more phases and preferably of one or more electric drives, are recorded with a high sampling rate, stored and statistically evaluated so that statistical characteristic values can be determined from a large amount of measurement values, and conclusions can be drawn and prognoses possibly made about the installation status or state of the drives from these statistical characteristic values. As used within the framework of the invention, a high sampling rate means a sampling rate of more than 0.2 Hz, e.g., at least 0.5 Hz, preferably at least 1 Hz. As a rule, a sampling rate of less than 10 Hz, e.g., less than 5 Hz, is sufficient to prevent excessively large amounts of data. Consequently, it is particularly preferable to measure at least one measurement value per second. Consequently, an installation according to the invention is outfitted with suitable measuring devices for measuring the currents of the individual drives at such a sampling rate. The measurement values are stored as series of measurement values in a database and are statistically or stochastically evaluated with an algorithm for detecting anomalies.

According to the invention, the current or currents of the drive or drives, e.g., the respective instantaneous values, the rectified value or the effective value, are measured.

The method is preferably used in an installation in which a plurality of drives are present which, e.g., are formed, respectively, as polyphase drives with a plurality of phases in each instance. The installation is preferably a wind orientation control in which a plurality of (e.g., four) electric polyphase drives work on a common machine element, namely, on a bearing ring of an azimuth bearing. However, the method can also be employed in other types of installations with one or more drives which can be formed as single-phase or polyphase drives and/or as DC drives. For example, DC drives are also used in wind turbines for emergency running, e.g., related to blade adjustment.

Series of measurement values, each with a plurality of measurement values, are preferably constantly recorded for each motor current or each individual phase of each individual drive. Each series of measurement values can have, e.g., 100 to 2000 measurement values, preferably 400 to 1000 measurement values. For example, series of measurement values with 600 measurement values each can be recorded. Accordingly, individual “clusters” are preferably formed for every m measurement points, e.g., 600 measurement points. The series of measurement values which comprehend a motor operation of ten minutes, for example, need not be recorded uninterruptedly but, rather, can also be compiled from a plurality of operating phases, e.g., during a wind orientation control in which the drives are operated for only a few seconds in each instance so that a series of measurement values comprises a plurality of tracking phases.

The evaluation and analysis are carried out based on the series of measurement values. In the first step of the evaluation, statistical characteristic values are calculated from the series of measurement values.

The statistical characteristic values can be those which merely characterize a motor current of a drive or an individual phase of an individual drive without taking into account a correlation between individual phases or drives. Statistical characteristic values of this kind which are associated, respectively, with an individual phase of an individual drive can be, e.g., the mean values of each individual phase, the measurement value density, the RMS (root mean square) of the series of measurement values, the value of the highest measurement value density, the minimum, the maximum, the standard deviation, the variance, the first sigma, the second sigma, the third sigma, or the median. Statistical characteristic values can also be calculated from the values of a plurality of series of measurement values, e.g., the mean value of all of the phases of a drive.

Alternatively or additionally, statistical characteristic values are calculated from the series of measurement values of a plurality of phases and/or a plurality of drives which characterize a correlation or relationship between a plurality of phases or a plurality of drives. This can be, e.g., the covariance of the series of measurement values or measurement value curves, e.g., the covariances of the measurement value curves M (1, 2, 3, 4) L1 to M (1, 2, 3, 4) L2, or M (1, 2, 3, 4) L2 to M (1, 2, 3, 4) L3, or M (1, 2, 3, 4) L3 to M (1, 2, 3, 4) L1. The correlation coefficients for these respective pairs of series of measurement values can be calculated in the same way, for example.

In a second step of the evaluation, the calculated statistical characteristic values are stored in an evaluation device and preferably provided in each instance with a timestamp. The evaluation device can comprise, in particular, a database server in which the calculated statistical characteristic values are stored.

In a third step, the previously calculated statistical characteristic values are ordered or analyzed. As was described above, the statistical characteristic values can be statistical characteristic values associated with individual currents or individual phases of individual drives (e.g., mean values, variance) or statistical characteristic values which already represent a relationship between individual phases of individual drives or the phases of different drives (e.g., covariance, correlation coefficient).

In a possible first embodiment form, the measurement values which represent a correlation between a plurality of phases or a plurality of drives are ordered during the evaluation, e.g., the covariances or correlation coefficients are evaluated in order to generate state information therefrom for one or more drives. For example, in the case of properly functioning new drives, there are low covariances between the phases/drives. In contrast, when there is a higher covariance between individual phases or individual drives, it can be concluded from this that the respective drive has a defect. It is advisable in this respect not to take into account the absolute values of the covariance or to compare the covariance in an actual situation with determined limiting values or threshold values for the covariance. Instead, it is particularly advisable to analyze the temporal progression of the covariance in order in this way to detect conspicuous developments indicating damage or an anomaly which could lead to damage in the future. A prerequisite for the evaluation or analysis of the temporal progression of the covariance is the measurement of a plurality of motor currents or phase currents so that anomalies relating to the relationship between these phase currents can be detected via the covariance.

Information or state information can be obtained in the same manner via the correlation coefficients between individual phases or individual drives. In this regard, a value of 1 of the correlation coefficient represents a perfect linear relationship, and a value of 0 stands for the complete absence of a linear relationship. It is then possible, for example, to adapt a limiting value for a correlation coefficient which generates a warning message and/or an error message. For example, a correlation coefficient of 0.7 to 0.6 can bring about a warning message, and a correlation coefficient of less than 0.6 can generate an error message. It may also be advisable in the analysis of the correlation coefficient to monitor the progress of the correlation coefficient over a determined time period and to detect and prognosticate disturbances, damage or anomalies in this way.

In this respect, it is especially important in particular installations, e.g., in a wind orientation control system, that the drives transmit their mechanical energy to the same machine element, e.g., the same ring gear, so that the occurring loads are also distributed to all of the drives. This has the result that the individual phase currents of the individual drives are correlated. For this reason, the correlation coefficient (or the covariance) is an important and informative indicator for the state of each individual drive.

While measurement values or series of measurement values which represent a correlation between a plurality of motor currents or a plurality of phases of one or more drives are always taken into account in the first embodiment form described above, it is provided in a possible second embodiment form to analyze individual characteristic values or a plurality of characteristic values which only relate to one drive or one phase or one current without involving a relationship between a plurality of phases or drives or requiring data of an (additional) reference system. To this end, the time evolution of the characteristic values of such a current or an individual phase of a drive is analyzed, e.g., by ordering based on previously determined and stored characteristic values, or in that characteristic values are first determined and stored as reference values in a learning phase. For this purpose, it is advisable that measurement distribution functions or distribution density functions are determined from the continuously recorded series of measurement values and stored in turn in characteristic values or characteristic numbers, and characteristic values or characteristic numbers are determined therefrom. This can be, for example, the characteristic values/characteristic numbers already mentioned above which relate, respectively, to the distribution function or the density distribution, e.g., the spread, the first, second or third sigma, the modal value, the variance, the minimum, the maximum, the standard deviation and/or the median. In this way, a monitoring or analysis of individual drives is achieved via a time series analysis without requiring data from a reference system. Within the framework of a trend value analysis, wear can be detected or damage can be detected or prognosticated.

This means that, also taking into account an individual drive or an individual phase, the statistical characteristic values which are determined in each instance from the continuously consecutively recorded series of measurement values can be correlated, and correlation coefficients can be determined therefrom. The above-mentioned state information and/or state prognoses can be derived from the correlation coefficient or from the time evolution thereof.

Accordingly, there exists the possibility of correlating the calculated statistical characteristic values in a trend value analysis with statistical characteristic values which were measured and calculated in the past, (e.g., in a learning phase) and determining trend values from this correlation and generating state information therefrom for one or more motors/drives. The calculated statistical characteristic values are accordingly subjected to a trend value analysis for detecting anomalies. By taking into account the correlation with historical values (learning phase) the determined trend values supply state information or a characteristic number from which a defect can be determined.

Optionally, the determined trend values are correlated not only with past characteristic values but also with characteristic values of the other drives and/or phases found in the system and are integrated in the determination of the state information or characteristic number by correlating with other drives and/or phases. In sum, a defect can be detected from the state information or characteristic number, e.g., in a drive or motor, in the associated gear units, in the toothing (of the bearing ring) or in a brake system. Progressive defects can also be reliably detected by means of a time series analysis or trend value analysis of the derived values. When all of the drives function properly without limitations, the trend values of the calculated characteristic values behave statically. However, if significant deviations of the trend values or acute deviations from other drives of the system are manifested or if abstract values are detected, an error or defect can be detected. The trend value analysis is implemented by means of an evaluation algorithm in the evaluation device.

The measurement value densities can also always be utilized for the evaluation. The measurement value densities or density functions are again recorded and stored as series of measurement values (e.g., clusters each with, e.g., 600 measurement values). From this, a trend value calculation over the entire running time can be carried out. Accordingly, a rising or falling trend value may be an indication of a malfunctioning of the drive. The trend values are again compared and correlated. But individual statistical characteristic values of individual phases can also supply important information independent from or in addition to a correlation as has been described. For example, acute disturbances can also be determined by evaluating the first sigma, the second sigma, and/or the third sigma.

Of especial significance is the fact that there is no comparison of measurement values or any simple comparison of statistical characteristic values (e.g., mean values) in the invention but, rather, that there is always a correlation of series of measurement values or the statistical characteristic values determined therefrom. Accordingly, preferred correlation coefficients are determined and the evolution of correlation coefficients is analyzed. Accordingly, the totality of all of the determined measurement values is preferably included in the determination of coefficients.

In sum, a reliable monitoring/analysis of the drives for the reliable detection of faults and prevention of damage is achieved through the measurement of currents and, e.g., phase currents of all of the phases of a plurality of drives with a high sampling rate and through a statistical evaluation with an algorithm. The method according to the invention operates neither with statistical reference values nor with specified set values. Characteristic parameters of the drives are correlated, for example, in order to detect a defective drive or drives, namely, including corresponding torque converters. Accordingly, conclusions may be drawn not only about the state of individual motors but also about the entire yaw system. The system need not be parameterized for the respective installation. Communications settings need merely be adjusted so that the system is easy to install or implement without needing to set especially high requirements for the qualifications of the installer.

Since, for example, data from a plurality of installations, e.g., wind turbines, are preferably analyzed on a central server, the centralized calculation of data affords the possibility to make use of correlations of the calculated motor parameters of an entire wind farm and to obtain even more informative results, e.g., for prognoses. Optionally, there also exists the possibility of forming the evaluation algorithm so as to make it possible to exactly locate damage and/or wear by combining different evaluations. For example, damage or impending damage to the brake, shaft, gearbox or ring gear can be selectively distinguished by suitable analyses based on the characteristic numbers.

It is especially important that the system affords the possibility not only to detect actual damage or wear but especially to indicate future onset of damage, namely, long before damage occurs or a drive fails and overloads the rest of the drives.

The algorithm can also use methods of artificial intelligence or neuronal networks or can be implemented with these methods so that the system is self-teaching because all of the data of each individual drive are permanently stored in the database for long periods of time and are available for analysis.

It is important that the invention dispenses with a direct comparison of the measured motor currents and, rather, takes into account statistical characteristic numbers and, for example, interprets them using a time series analysis. The invention has recognized that a simple comparison of individual motor currents is not suitable for assessing damage because, for example, in a freewheeling motor, no irregularities would appear even in the event of a shaft break because of the rated current consumption. Owing to the above-mentioned disturbance variables and environmental influences, extreme hystereses occur in the current consumption so that a simple comparison of the individual motor currents would not be suitable. Moreover, every electric motor has manufacturing tolerances which cannot be determined because of the above-mentioned external influencing factors, and this also prevents a static determination of current consumption limiting values for error detection. Therefore, a mathematical or stochastic/statistical evaluation of calculated characteristic numbers is carried out according to the invention.

The subject matter of the invention is directed not only to the method described above but also to the electromechanical installation itself, i.e., an electromechanical installation which may be formed, e.g., as wind orientation control of a wind turbine. An electromechanical installation has at least one moveable machine element on which one or more drives operate. The installation is adapted to implement the above-described method, i.e., it is provided with or connected to a control and an evaluation device which are adapted to implement the above-described method.

In a particularly preferred manner, the electromechanical installation is a wind orientation tracking arrangement of a wind turbine in which a plurality of AC motors work on a common bearing ring or ring gear of an azimuth bearing. However, also included are other electromechanical installations in which preferably a plurality of drives operate on a common machine element. Accordingly, the invention can also be employed, e.g., in crane installations, e.g., rotary gantry cranes. Timely damage indication is always a priority. Further, the invention also affords the possibility of monitoring installations with individual drives. It is also possible to monitor installations with DC drives with the invention.

In a particularly preferred manner, the storage and evaluation of data is carried out externally or outside of the actual electromechanical installation, e.g., outside of the wind turbine. Accordingly, in a preferred further development, the invention suggests providing the installation with a local control device with which the measurement values are recorded. The measurement values can possibly be stored temporarily. However, a permanent storage of the measurement values or series of measurement values and an evaluation of the measurement values are preferably not provided in the local control device. Rather, the measurement values are preferably transmitted (e.g., by cable/optical fiber or mobile wireless communications) to an externally arranged evaluation device which can be realized highly remotely independent from the wind turbine. An evaluation device of this kind has, e.g., a database server with evaluation software so that the series of measurement values are stored on the database server and evaluated with an evaluation algorithm. The external evaluation device can be associated, e.g., as central control room, with a plurality of wind turbines. The evaluation device preferably has an interface via which the state information can then be polled in turn by external terminals or transmitted to external terminals, e.g., to PCs, tablets or smartphones. This makes it possible to transmit warning messages from the database server to various terminals or to poll state information from the database server with the terminals.

Further, there exists the possibility of automatically influencing the electromechanical installation in that the installation, e.g., the wind orientation control, is stopped when a determined error event is recorded. Accordingly, the system according to the invention can be adapted in such a way that an installation, e.g., wind turbine, is stopped automatically and therefore shut down in response to determined state information. In this way, severe damage to the installation or secondary damages can be prevented.

### BRIEF DESCRIPTION OF THE DRAWINGS

The invention will be described in the following referring to drawings showing only one embodiment example. The drawings show:

FIG. 1 a highly simplified schematic depiction of an electromechanical installation embodied as wind orientation control with a state monitoring arrangement according to the invention;

FIG. 2 an enlarged detail from the installation in FIG. 1;

FIGS. 3A, 3B statistical characteristic values (covariances) for properly functioning (new) drives on the one hand and defective drives with increased slip on the other hand;

FIGS. 4A, 4B statistical characteristic values (correlation coefficients) for the drives according to FIGS. 3A, 3B; and

FIGS. 5A, 5B simplified histograms and distribution density functions.

### DETAILED DESCRIPTION OF THE EMBODIMENTS

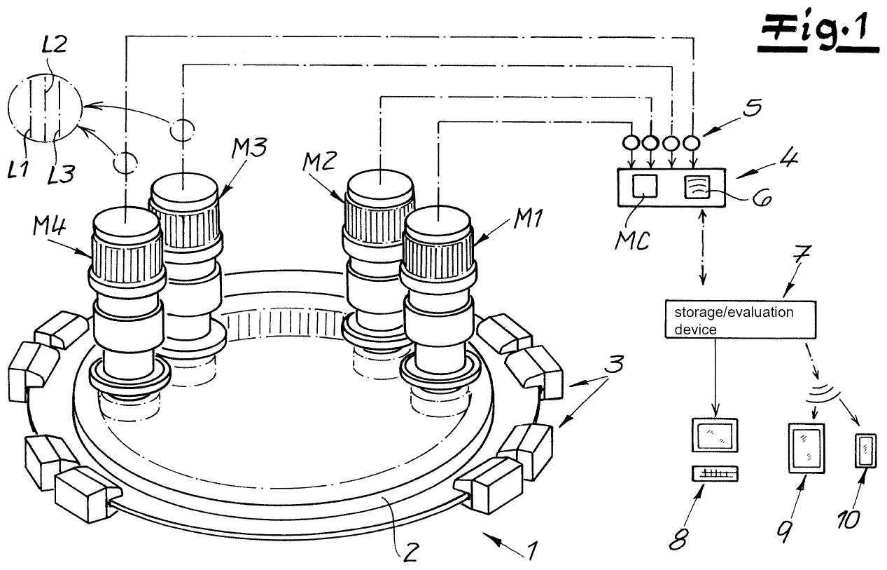

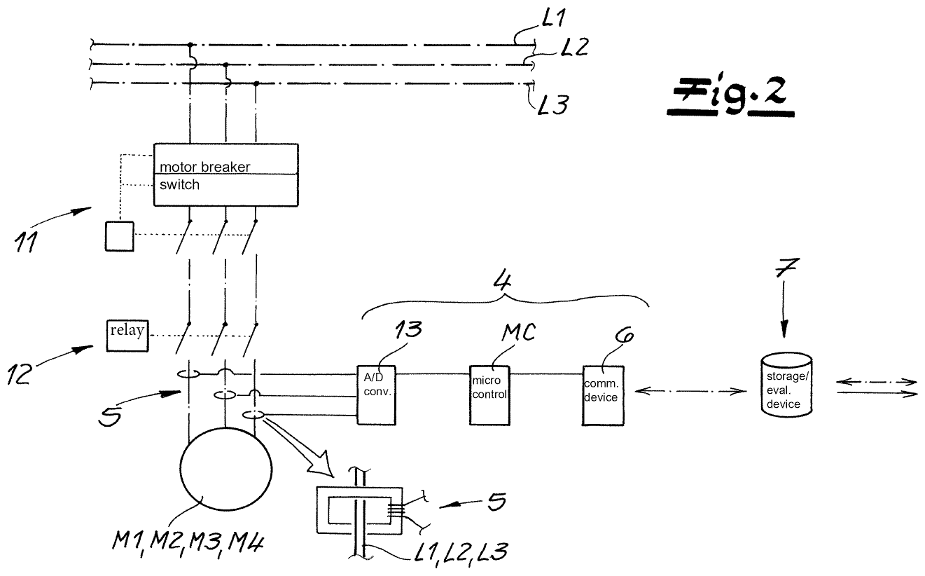

FIGS. 1 and 2 show a highly simplified schematic depiction of an electromechanical installation embodied as wind orientation control, specifically with a state monitoring arrangement for the electric drives of the wind orientation control.

The wind orientation control serves to adjust the nacelle of a wind turbine in direction of the prevailing wind. The nacelle is rotatably supported at the tower head and can be adjusted by a plurality of electric drives. FIG. 1 shows a simplified detail of a tower head bearing 1 with a bearing ring 2 on which a plurality of electric drives M1, M2, M3, M4 operate. An exemplary arrangement with internal toothing of the azimuth bearing and with internal drives and external azimuth brake 3 is shown. The electric drives are connected to a control device 4 which is arranged in the wind turbine, e.g., in the tower head or in the nacelle. The drives are formed as three-phase AC motors. In the embodiment example, there are four drives M1, M2, M3, M4, all of which act on the same machine element, namely, the same bearing ring 2. The control device 4 activates the drives, as needed, in order to adjust the nacelle to a change in wind direction. According to the invention, the drives are outfitted with, or connected to, measuring devices 5 with which the phase currents of all three phases L1, L2, L3 of each individual drive M1, M2, M3, M4 are measured. Further, conventional protective devices, e.g., a motor breaker switch 11 and a relay switch 12, which can be provided in a conventional manner are indicated in FIG. 2. All of the phase currents of the drives are detected by the measuring devices 5 with a high sampling rate, e.g., 0.5 Hz to 5 Hz, e.g., approximately 1 Hz, i.e., every second. Startup spikes and stop spikes are already factored out of the installation by the measuring devices 5 or by the control device 4. During the operation of the motors, which generally only lasts a few seconds within the framework of a wind orientation control, the measurement values are (temporarily) buffered in the control device 4. The measurement values are conveyed (e.g., via TCP/IP) to an evaluation device or storage/evaluation device 7 (e.g., after measurement is concluded or after the wind orientation control is halted) via an A/D converter 13 and a microcontroller MC by means of an interface or communications device 6. For example, the storage/evaluation device 7 is formed as, or outfitted with, a database server for storing large amounts of data, and evaluation software is stored in the evaluation device 7. The measurement values are evaluated in the storage/evaluation device and state information for the drives M1, M2, M3, M4 is generated therefrom. This state information can be polled and visualized via various terminals, e.g., a PC 8, a tablet 9 or a smartphone 10. The terminals can communicate with the evaluation device 7 in a wired or wireless manner.

In the depicted embodiment example, all three phase currents L1, L2, L3 are accordingly measured for all of the motors M1, M2, M3 and M4, that is, with the high sampling rate of, e.g., 1 Hz as was described above. Series of measurement values with a predetermined quantity m of measurement values are stored in each instance, 600 measurement values per series of measurement values in the embodiment example, i.e., the measurement values are stored in clusters of 600 measurement points, namely, for every individual phase of every motor so that, in the embodiment example, twelve series of measurement values are generated and stored. At a sampling rate of 1 Hz and 600 measurements per series of measurement values, one series of measurement values represents a time period of 10 minutes. This time period does not represent one continuous measurement but rather covers the total operation of the respective drive as a result of a plurality of temporally consecutive wind orientations. Consequently, complete series of measurement values need not be stored in the control device 6 which is located in the area of the drives; rather, only the individual measurements are temporarily stored during the operation of the drives and transmitted to the storage/evaluation device 7. The measurement values are collected in the latter as series of measurement values so that they can undergo an evaluation subsequently.

It is particularly important that a statistical/stochastic evaluation and analysis of the measuring value series is carried out according to the invention, that is, statistical characteristic values are generated from the series of measurement values, namely, e.g., characteristic values for a correlation between a plurality of phases or a plurality of drives on the one hand and statistical characteristic values for individual phases of the respective drive on the other hand. State information for one drive or for all of the drives can be generated individually or through suitable combinations from these statistical characteristic values, namely, with the evaluation software stored in the storage/evaluation device 7 or with an evaluation algorithm which generates the state information representing the respective state of the individual drives.

Accordingly, for example, one or more of the following statistical characteristic values can be formed from the final m measurements, e.g., 600 measurements, and therefore from each individual series of measurement values (via the measurement distribution densities) for each drive and each phase:
mean value of each individual phase, mean value of the total L1/L2/L3, i.e., (sum L1/600+sum L2/600+sum L3/600)/3, mean value of the individual phase measurements (L1+L2+L3)/3, RMS, measurement value density, value of the highest measurement value density or maximum of the measurement value distribution, minimum of the series of measurement values, maximum of the series of measurement values, standard deviation, variance, first sigma, second sigma, third sigma, median.

These statistical characteristic values contain statistical information about the series of measurement values without taking into account relationships between individual series of measurement values.

Additionally, it is particularly advantageous to calculate statistical characteristic values for a correlation between a plurality of series of measurement values, i.e., series of measurement values of a plurality of phases and a plurality of drives. This has to do chiefly with covariances of the measurement value curves and/or the correlation coefficients. Accordingly, for example, all of the covariances and correlation coefficients for all possible combinations of series of measurement values (M (1−N) Li to M (1−n) Lj can be evaluated. All of the statistical characteristic values are provided with a timestamp and stored in the evaluation/storage device. An evaluation of the stored statistical characteristic values is carried out with the stored algorithm in that the statistical values are ordered and analyzed, and the state of the installation or drives is deduced therefrom.

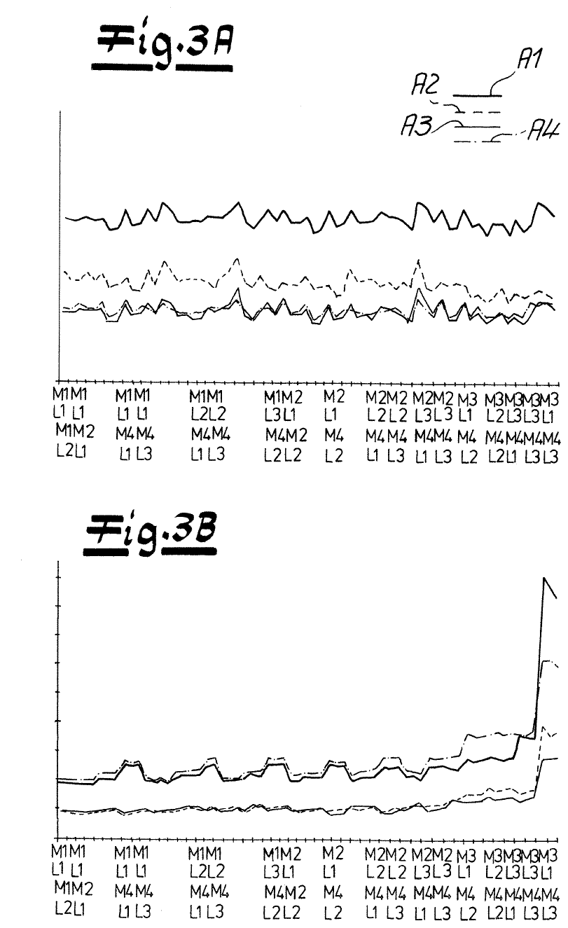

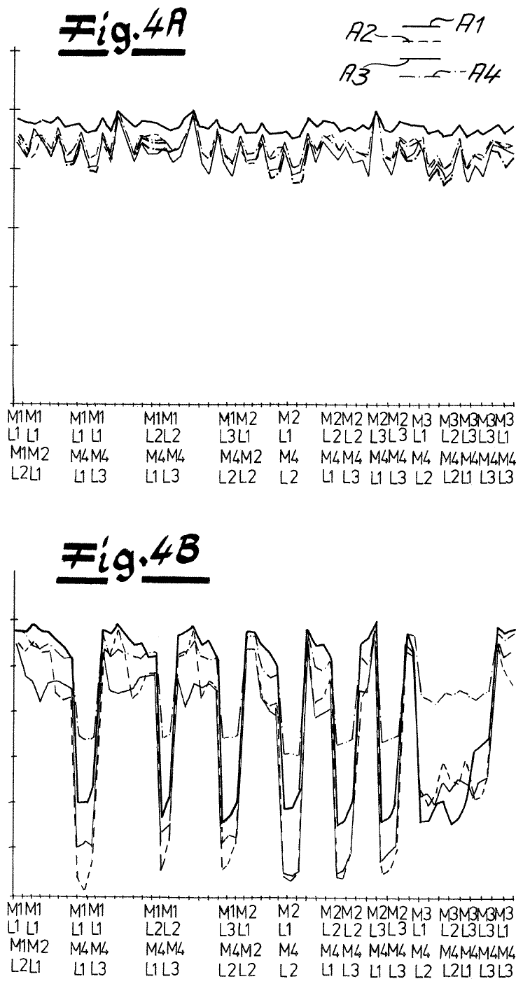

In this regard, reference is made, for example, to FIGS. 3A and 3B and to FIGS. 4A and 4B.

The covariances for a plurality of series of measurement values for a new or properly working drive or plurality of drives are plotted in FIG. 3A. Four consecutively recorded and evaluated measurement phases are shown, each with 600 measurement points and, consequently, over a time period of ten minutes. The individual evaluations are designated by A1, A2, A3 and A4. The covariances are plotted for the various combinations MₙLᵢ to MₙLⱼ. The letters on the x axis are provided only for some exemplary combinations. It will be seen that all of the covariances are relatively low so that it can be concluded that the drive or drives is/are working properly.

On the other hand, FIG. 3B shows a situation in which the covariances increase slightly whenever drive M4 is involved so that it can be concluded that drive M4 has a defect, e.g., increased slip. This is particularly evident in covariance M4L1 to M4L3, i.e., with a covariance in which the various phases of the same drive M4 are involved.

Similar information can be obtained through evaluation of the correlation coefficients according to FIGS. 4A and 4B. It will be seen again that the correlation coefficient is in a high range for all of the measurement phases (see FIG. 3A), while it drops to low values in case of a defective drive (compare FIG. 3B). It will be seen that this happens in correlation coefficients whenever drive M4 is involved so that a fault can be determined in the area of a drive in a particularly reliable manner via the correlation coefficient. Accordingly, the malfunctioning motors can be verified based on the comparison or based on relationships of the individual correlation coefficients, and this can be done in a timely manner before damage occurs. It is particularly important that the time evolution of these covariances or correlation coefficients can be analyzed within the framework of a time series analysis or trend value analysis.

FIGS. 3A, 3B and 4A, 4B show only an exemplary evaluation and analysis of determined statistical characteristic values. In a particularly preferable manner, further statistical characteristic values are evaluated and monitored so that different types of error or types of wear can be detected.

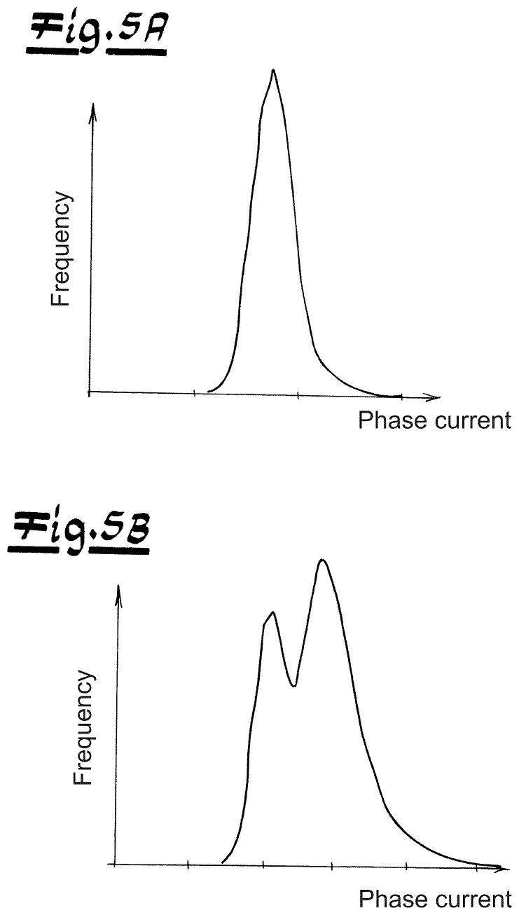

FIGS. 5A and 5B show exemplary histograms and distribution density functions of series of measurement values for a drive in new condition (FIG. 5A) and a defective drive (FIG. 5B). It will be seen that the measurement value distribution for a drive in new condition is approximately normal. The frequency of the phase currents indicated on the x axis is plotted. On the other hand, FIG. 5B shows a distribution for an already existing installation having a defect. These measurement distribution densities can be stored in statistical characteristic numbers, or statistic characteristic numbers, e.g., the spread, the first, second and third sigmas, the modal value, the variance, the minimum, the maximum, the standard deviation and/or the median, can be determined from the distribution densities. By taking into account the correlation with stored reference values or, in particular, by means of an analysis of the time evolution of these statistical characteristic values, an individual drive or an individual motor current can be analyzed or monitored, and wear can be reliably detected or prognosticated without having to monitor a reference system. Only the data of the drive which were previously stored are needed as reference in that the time evolution of the distribution density function or characteristic numbers thereof is analyzed. Accordingly, for example, the three sigma values are utilized for verification of temporary measurement in order to reliably detect acute occurrence of damage. For example, when measurement values accumulate outside of the sigma values, this is an indication of an error, and the farther the measurement value is from the modal value, the clearer and more acute the error event. By monitoring or analyzing an individual drive or an individual phase in this way (without taking into account a reference system), correlations of the series of measurement values recorded over time and the characteristic values determined therefrom can also be analyzed, and correlation coefficients can be determined and evaluated.

It is further advantageous that the storage of the very extensive data and the evaluation are not carried out in the local control 4 in the wind turbine, but rather only the measurement and transmission of the measurement values is carried out in the latter (possibly after temporary buffering). The storage/evaluation device 7 is generally far away from the wind turbine so that, e.g., a plurality of wind turbines can be monitored via a central monitoring device.

Further, visualization software can be additionally stored in the storage/evaluation device 7. This visualization software visually displays the collected and derived values from the database for the user and serves as communications interface between the evaluation algorithm and the user. A corresponding reaction to the error event, e.g., a warning email or on-demand stoppage of the wind orientation control, can also be carried out.

Further, the storage/evaluation device 7 is shown in a highly simplified manner in the drawings. It can comprise a database server in particular. The software for data evaluation, anomaly detection and error reporting can also be stored on the same server. Alternatively, however, an additional computer/server can be provided for implementing the evaluation, anomaly detection and error reporting.

1. A method for monitoring one or more electric drives (M1, M2, M3, M4) of an electromechanical installation, wherein the drive or drives (M1, M2, M3, M4) work on a movable machine element of the installation, comprising the steps of:
measuring one or more motor currents of one or more of the drives (M1, M2, M3, M4) during the operation of the drives at a predetermined sampling rate and storing the measured one or more currents as a series of measurement values which is associated with a respective one of the drives and has a predetermined quantity (m) of measurement values in each instance, wherein statistical characteristic values of each respective drive (M1, M2, M3, M4) are calculated from one or more series of measurement values, wherein one or more pieces of state information and/or one or more state prognoses are/is generated for one or more of the drives through analysis of the time evolution of the characteristic values and/or through analysis of a relationship of the characteristic values of different motor currents.

2. The method according to claim 1, wherein the sampling rate is more than 0.2 Hz.

3. The method according to claim 1, wherein each series of measurement values has 100 to 1000 measurement values.

4. The method according to claim 1, wherein the installation has one or more single-phase or polyphase AC drives as the drives (M1, M2, M3, M4).

5. The method according to claim 1, wherein the installation has one or more DC drives as the drives.

6. The method according to claim 1, wherein a plurality of the drives (M1, M2, M3, M4) are provided, all of which work on the same movable machine element, and wherein these drives are each formed as polyphase drives, each with a plurality of phases (L1, L2, L3).

7. The method according to claim 1, wherein the electromechanical installation is formed as a wind orientation control of a wind turbine, and wherein the movable machine element is formed by a bearing ring of an azimuth bearing.

8. The method according to claim 1, wherein measurement distribution functions or distribution density functions are determined from the series of measurement values and are stored, and/or wherein the characteristic values are determined from the measurement distribution functions or distribution density functions, and the distribution functions or distribution density functions are recorded in characteristic values, respectively.

9. The method according to claim 1, wherein one or more of the characteristic values are calculated from the following groups and possibly intermediately stored as statistical characteristic values from individual series of measurement values for the respective motor current or the respective phase of the respective drive: mean values of individual currents/phases or of all currents/phases, mean value of all of the currents/phases of a drive, minimum, maximum, standard deviation, variance, first sigma, second sigma, third sigma, median, RMS (effective value), sum of the squares, measurement value density, value of the highest measurement value density.

10. The method according to claim 1, wherein one or more of the characteristic values are calculated from the following group and intermediately stored as statistical characteristic values from a plurality of series of measurement values of different phases and/or different drives: covariance, correlation coefficient.

11. The method according to claim 1, wherein a time evolution of the characteristic values of a current or phase, respectively, or of a drive is analyzed by carrying out an ordering based on previously determined and stored characteristic values, wherein, characteristic values are first determined as reference values in a learning phase and are stored, and/or wherein temporally consecutively determined characteristic values are correlated.

12. The method according to claim 1, wherein the relationship or the time evolution of the relationship of characteristic values of different currents or phases, respectively, or drives is analyzed, by correlating characteristic values or the temporal progression of characteristic values.

13. The method according to claim 1, wherein statistical characteristic values which represent a relationship of a series of measurement values of different currents or phases, respectively, or drives, the statistical characteristic values being in the form of covariances and/or correlation coefficients, are analyzed by correlating with stored reference values or limiting values or analyzing their temporal progression.

14. The method according to claim 1, wherein the measurement values are recorded in the installation and intermediately stored, and wherein the determined measurement values are transmitted to an externally arranged evaluation device and are stored and evaluated in the evaluation device as series of measurement values.

15. The method according to claim 1, wherein a feedback is generated from the determined state information and fed back to the installation, and wherein the operation of the installation is adapted depending on the feedback by interrupting or modifying the operation of the installation depending on the state information or feedback, respectively.

16. An electromechanical installation, having at least one moveable machine element, and having one or more electric drives (M, M2, M3, M4) which work on the moveable machine element, wherein the installation is adapted to implement a method according to claim 1.

17. The installation according to claim 16, wherein the drives are outfitted with, or connected to, one or more measuring devices (5) for measuring the motor currents.

18. The installation according to claim 16, wherein the installation is outfitted with a local control device (4), wherein the measurement values are measured with the control device (4) and are locally intermediately stored in the control device, and wherein the measurement values are transmitted to an externally arranged evaluation device (7) which, has a data server and/or evaluation server with an evaluation program.

19. The installation according to claim 16, wherein the external evaluation device has an interface via which the state information is transmittable to one or more terminals or is pollable by one or more terminals (8, 9, 10).
